(19) United States
(12) Patent Application Publication
(10) Pub. No.: US 2013/0268394 A1
(43) Pub. Date: Oct. 10, 2013

(54) DYNAMIC RECOMMENDATIONS BASED ON PSYCHOLOGICAL TYPES

(71) Applicant: Andrey N. Nikankin, Sankt-Petersburg (RU)

(72) Inventor: Andrey N. Nikankin, Sankt-Petersburg (RU)

(73) Assignee: RAWLLIN INTERNATIONAL INC.

(21) Appl. No.: 13/443,542

(22) Filed: Apr. 10, 2012

(51) Int. Cl. G06Q 30/00

(52) U.S. Cl. 705/26.7

(57) ABSTRACT

Disclosed are electronic systems and techniques for implementing dynamic recommendations based on psychological types. A dynamic association component can associate recommendation features employed in a network site, such as a web portal, with respective psychological types based on a set of usage data for the web portal and/or the recommendation features. A dynamic feature provisioning component can determine a psychological type corresponding to a user, and provide recommendation features associated with the psychological type to the user during interaction with the web portal.

### TECHNICAL FIELD

The subject application relates to recommendation features, and, more particularly, to dynamic recommendations based on psychological types.

### BACKGROUND

The Internet and other networks that transport data are continually changing the way commerce is conducted. Consumers can currently shop for everything from automobiles to digital media products using a computer, mobile device, etc. Compared to traditional retail outlets where shelf space is limited, online retailers are able to offer a virtually limitless number of products and options. However, the sheer quantity of options available online can make selecting or finding a desirable product challenging for many consumers.

Recommendation systems are a common technique employed by online retailers to assist users in making or finding purchasing options. Typically, an online retailer must select a recommendation system to be employed during designing/building of their e-commerce platform. However, current recommendation systems lack versatility. A recommendation system may provide the greatest convenience and utility to one group of consumers, but be ineffective or undesirable for other groups of users. A redesign of the platform and/or recommendation system is often the only option available to retailer's when a current recommendation system is not achieving desired results.

The above-described deficiencies of today's recommendation systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for dynamic recommendations based on psychological types are contained herein. An exemplary system includes a dynamic association component configured to associate recommendation features employed in a network site, such as a web portal, with respective psychological types, and a dynamic feature provisioning component configured to determine a psychological type corresponding to a user, and provide the recommendation features associated with the psychological type to the user.

In another non-limiting embodiment, an exemplary method is provided that includes determining a set of usage data for at least one of a network site, such as a web portal, or a set of recommendation features employed in the network site, modifying associations of respective personality types and recommendation features based on the set of usage data, determining at least one of the respective personality types corresponding to a user of the network site, and providing recommendation features to the user associated with the at least one respective personality type.

In still another non-limiting embodiment, an exemplary computer readable storage medium is provided that includes determining a psychological type corresponding to a user based at least in part on a set of user data, updating a profile associated with the user based on the determined psychological type, and providing recommendation features associated with the personality type corresponding to the user.

In yet another non-limiting embodiment, an exemplary system is provided that includes means for determining a quantity of web portal users corresponding to a hybrid psychological type, wherein the hybrid psychological type is a combination of at least two psychological types included in a set of psychological types, means for determining that the quantity of users corresponding to the hybrid psychological type satisfies a predetermined threshold, in response to the quantity of users corresponding to the hybrid psychological type satisfying the predetermined threshold, and means for adding the hybrid psychological type to the set of psychological types.

### BRIEF DESCRIPTION OF DRAWINGS

FIG. 1 illustrates an example system for dynamic recommendations based on psychological types in accordance with various aspects described herein;

FIG. 2 illustrates an example dynamic association component in accordance with various aspects described herein;

FIG. 3 illustrates an example dynamic feature provisioning component in accordance with various features described herein;

FIG. 4 illustrates an example profiling component in accordance with various aspects described herein;

FIG. 5 illustrates a block diagram of an exemplary non-limiting system that provides additional features or aspects in connection with dynamic recommendations based on psychological types;

FIG. 6-8 illustrate example methodologies for dynamic recommendations based on psychological types in accordance with various aspects described herein;

FIGS. 9-11 illustrate flow charts for exemplary non-limiting systems that provide for dynamic recommendations based on psychological types in accordance with various aspects described herein;

FIG. 12 is a block diagram representing exemplary non-limiting networked environments in which various non-limiting embodiments described herein can be implemented; and

FIG. 13 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

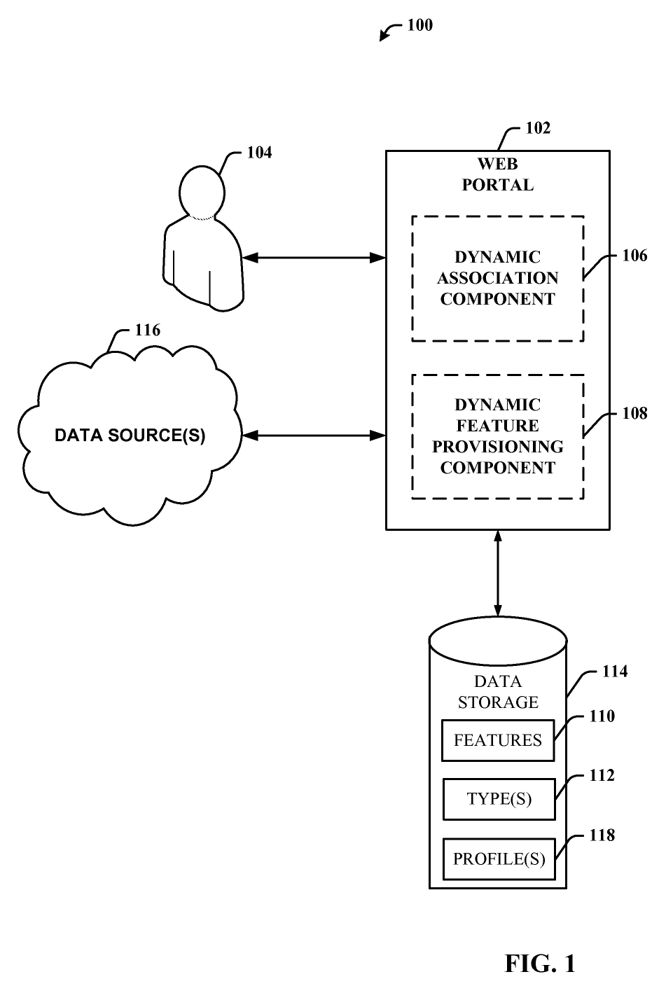

Referring initially to FIG. 1, illustrated is an example system 100 for dynamic recommendations based on psychological types in accordance with various aspects described herein. The system 100 includes a network site, such as a web portal 102. The web portal (e.g., web shopping portal, portal, etc.) 102 provides for users (e.g., user 104) to view, purchase, or otherwise consume goods. For example, the web portal 102 can include but is not limited to an online retailer of digital media products (e.g., songs, videos, video games, articles, etc.). The user 104 can access, communicate with, or otherwise connect to the portal 102, for example, from a computing device using a network connection (e.g., Internet, etc.). The computing device (device) can include but is not limited to a mobile phone, a smart phone, a laptop, a portable music player, a net book, a computer, a video game system, a global positioning system, and so forth. The web portal 102 includes a dynamic association component 106, and a dynamic feature provisioning component 108.

The dynamic association component 106 (association component 106) links, relates, or otherwise associates recommendation features included in a set of recommendation features 110 (features 110) with respective psychological types 112 based on a set of usage data for the web portal 102. For example, the psychological types 112 and features 110 can be initially unassociated. The association component 106 continually monitors usage of the web portal 102 by the users, and associates a first psychological type 112 with a subset of the features 110 based on the monitored usage of the web portal 102. For instance, if a usage rate for a first recommendation feature 110 by a set of users corresponding to a first psychological type 112 satisfies a usage threshold, then the dynamic association component 106 can associate the first recommendation feature 110 with the first psychological type 112.

As an additional or alternative example, an administrator can initially associate each psychological type 112 with a subset of the recommendation features 110 based on a default setup, standards, research, etc. The association component 106 can update the associations of respective psychological types 112 and features 110 based on the monitored usage. For example, a first psychological type 112 can initially be associated with a first subset of features 110. The dynamic association component 106 can update or re-associate the first psychological type 112 with a second subset of the features 110 based on the monitored usage.

The dynamic feature provisioning component 108 (provisioning component 108) infers or determines a psychological type 112 corresponding to the user 104, and provides recommendation features associated with the psychological type 112 to the user 104 during interaction with the web portal 102. The provisioning component 108 can determine the psychological type 112 corresponding to the user 104 based on explicit input from the user 104 (e.g., question and answer, etc.), and/or implicitly based on a set of user data for the user 104 (e.g., a profile 118). For example, if the user 104 employs a first recommendation feature 110 an amount of times satisfying a feature usage threshold, then the provisioning component 108 can determine a psychological type 112 associated with the first recommendation feature 110 as corresponding to the user 104.

Additionally or alternatively, the provisioning component 108 can obtain, receive, or otherwise acquire data related to the user 104 from a set of data sources 116. The data sources 116 can include virtually any open source or publicly available sources of information, including but not limited to websites, search engine results, social networking websites, online groups, online subscriptions, and so forth. For example, the provisioning component 108 can obtain a set of data relating to the user 104 (user data) by querying one or more Internet search engines. The provisioning component 108 can update a profile 118 associated with the user 104 based on the data obtained from the set of data sources 116.

The psychological types can include but are not limited to adventurous, conformist, introvert, extrovert, logical, thinking, sensory, feeling, intuitive, conscious, and/or unconscious. In addition, the recommendation features can include but are not limited to collaborative filter based recommendation features, content-based filter recommendation features, authoritative/expert based recommendation features, blended predictive features, and/or hybrid recommender features. It is to be appreciated that although the association component 106 and provisioning component 108 are illustrated as being included in the web portal 102 such implementation is not so limited. For example, the association component 106 and/or provisioning component 108 can be stand-alone components, and/or can be included in a device associated with the user 104. It is to be appreciated that although the recommendation features 110, the psychological types 112, and profiles 118 are illustrated as being maintained in a data storage 114, such implementation is not limited. For example, the recommendation features 110, the psychological types 112, and/or profiles 118 can be included in the web portal 102, and/or maintained in a separate location (e.g., cloud, other website, a device, etc.).

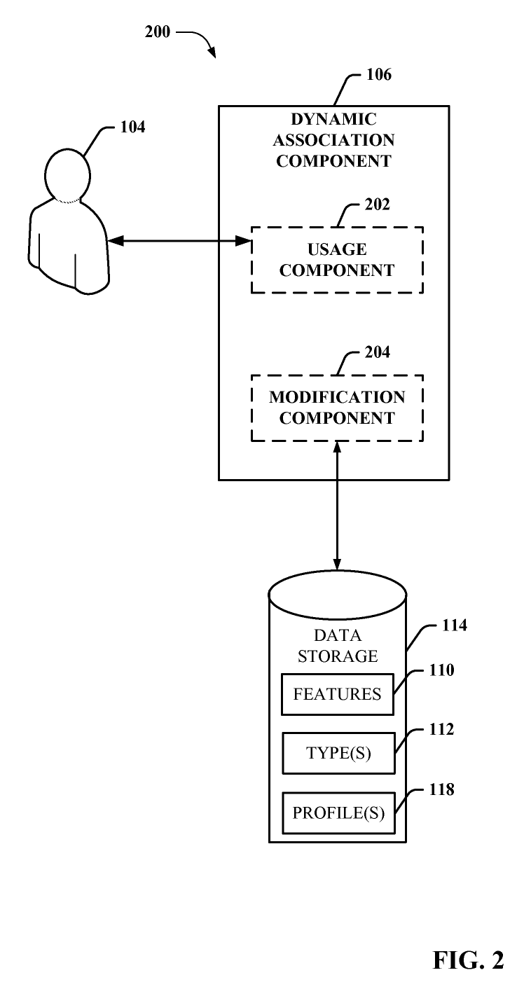

Turning to FIG. 2, illustrated is an example dynamic association component 106 in accordance with various aspects described herein. As discussed, the dynamic association component 106 (association component 106) associates recommendation features included in a set of recommendation features 110 (features 110) with respective psychological types 112 based on a set of usage data for the web portal 102. In one embodiment, the association component 106 includes a usage component 202, and a modification component 204. The usage component 202 tracks, monitors, or otherwise determines usage of the web portal 102 and/or recommendation features 110 by a set of users (e.g., user 104). The usage data can include user actions, such as viewing items, searching items, purchasing items, recommending items (e.g., via a social network, electronic mail, etc.), adding/removing items from a favorites lists (e.g., wish list, etc.), rating items, and/or correlations of respective recommendation features to the user actions. For example, the usage component 202 can determine a quantity (e.g., percentage, etc.) of users corresponding to a first psychological type that purchased songs in response to a first recommendation feature 110.

The modification component 204 updates, alters, or otherwise modifies the associations of psychological types 112 and features 110 based on the usage data. Returning to the previous example, if the quantity of users corresponding to the first psychological type 112 that purchased songs in response to a first recommendation feature 110 does not satisfy a set of recommendation criteria, then the modification component 204 can disassociate, or not associate, the first recommendation feature 110 and the first psychological type 112. The set of recommendation criteria can include but is not limited to a click-through threshold, a purchase threshold, an add-to-wish list threshold, a views threshold, and/or a viewing time threshold.

As an additional or alternative example, in one embodiment, the psychological types 112 are associated with recommendation schemes. The recommendation schemes can include subsets of the recommendation features 110. For example, a first recommendation scheme may include a first feature, a second feature and a fourth feature included in the set of features 110, and a second recommendation scheme may include the first feature, a third feature, and a fifth feature included in the set of features 110. The modification component 204 can modify the associations of psychological types 112 and recommendation schemes based on usage data. For example, if a quantity of users 104 corresponding to a second psychological type that purchased songs in response to a first recommendation scheme satisfies the set of recommendation criteria, then the modification component 204 associates the first recommendation scheme with the second psychological type 112. The recommendation schemes can include but are not limited to collaborative filtering, content-based filtering, authoritative based recommendations, blended predictive systems, and/or hybrid recommender systems.

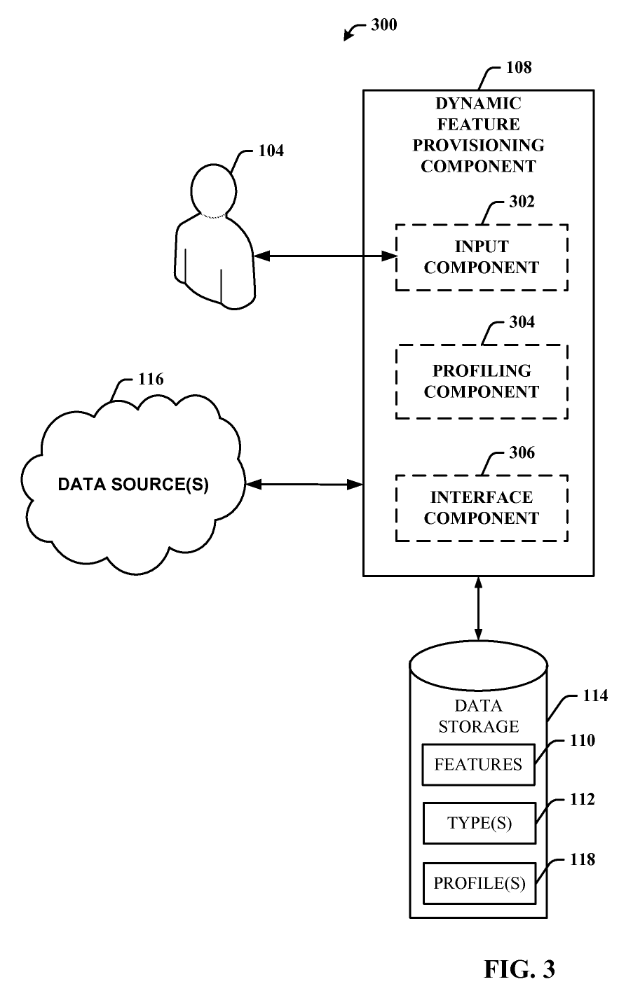

FIG. 3 illustrates an example dynamic feature provisioning component 108 in accordance with various aspects described herein. As discussed, the dynamic feature provisioning component 108 (provisioning component 108) dynamically infers or determines a psychological type 112 corresponding to a user 104, and provides recommendation features associated with the psychological type 112 to the user 104 during interaction with the web portal 102. In one embodiment, the feature provisioning component 108 includes an input component 302, a profiling component 304, and an interface component 306.

The input component 302 obtains, acquires, or otherwise receives inputs from the user 104. The inputs include explicit user inputs (e.g., configuration selections, question/answer, etc.) such as from mouse selections, keyboard selections, touch screen selections, and/or speech. In addition, the inputs can also include data uploads, wherein a data upload is a transfer of data from the user 104 or a third party source (e.g. computer or a computer readable medium), to the input component 302.

The profiling component 304 determines or infers a psychological type 112 corresponding to the user 104 based at least in part on a profile 118 associated with the user 104. The profile 118 includes a set of user data that can be explicitly and/or implicitly obtained. For example, the user 104 can explicitly provide a first subset of the user data as responses to a set of psychological profiling questions. For instance, the user 104 can be provided a set of psychological profiling questions when the user 104 initially visits or joins the web portal 102. As an additional or alternative example, the profiling component 304 can implicitly determine a second subset of the user data based at least in part on user actions (e.g., viewing items, searching items, purchasing items, recommending items, adding/removing items from a favorites lists, rating items, etc.), and/or data obtained from a set of data sources 116. The data sources 116 can include virtually any open source or publicly available sources of information, including but not limited to websites, search engine results, social networking websites, online groups, online subscriptions, and so forth. For example, the profiling component 304 can obtain a set of data relating to the user 104 (user data) by querying one or more Internet search engines, and update a profile 118 associated with the user based on the data obtained from the set of data sources 116.

The profiling component 304 analyzes the profile 118 associated with the user 104, and determines a psychological type 112 corresponding to the user 104 based at least in part on user data included in the profile 118. For instance, the profiling component 304 can determine that the user 104 corresponds to an adventurous psychological type 112 based on a set of answers provided by the user 104 to a set of psychological profiling questions. In response to the profiling component 304 determining that the user 104 corresponds to an adventurous psychological type 112, the provisioning component 108 can provide the user 104 with a subset of features 110 included in a collaborative filtering scheme, wherein the collaborative filtering scheme is associated with the adventurous psychological type (e.g., by the association component 106).

The interface component 306 includes any suitable and/or necessary adapters, connectors, channels, communication paths, etc. to integrate the provisioning component 108 into virtually any operating and/or database system(s). Moreover, the interface component 306 can provide various adapters, connectors, channels, communication paths, etc., that provide for interaction with the provisioning component 108. It is to be appreciated that although the interface component 306 is illustrated as incorporated into the provisioning component 108, such implementation is not so limited. For instance, the interface component 306 can be a stand-alone component to receive or transmit data in relation to the provisioning component 108.

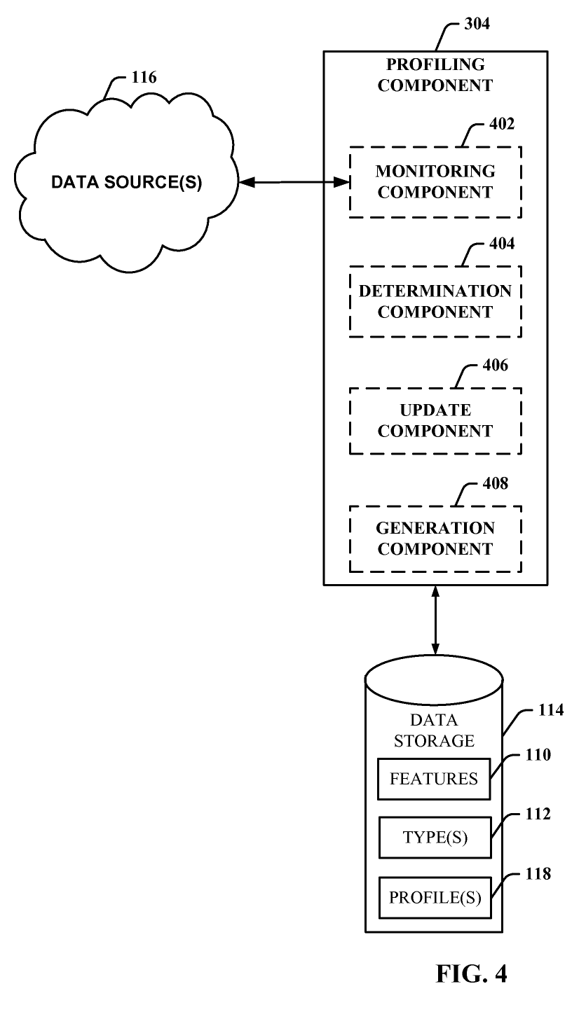

Referring to FIG. 4, illustrated is an example profiling component 304 in accordance with various aspects described herein. As discussed, the profiling component 304 determines or infers a psychological type 112 corresponding to a user 104 based at least in part on a set of user data included in a profile 118 associated with the user 104. In one embodiment, the profiling component 304 includes a monitoring component 402, a determination component 404, an update component 406, and a generation component 408.

The monitoring component 402 continuously tracks, monitors, or otherwise determines user data for the user 104, and adjusts, alters, or otherwise modifies a profile 118 associated with the user 104 based on the user data. As discussed, the user data can relate to user actions, such as viewing items, searching items, purchasing items, recommending items (e.g., via a social network, electronic mail, etc.), adding/removing items from a favorites lists (e.g., wish list, etc.), rating items, and correlations of respective recommendation features (or schemes) to the user actions. For example, the monitoring component 402 determines a quantity (e.g., percentage, etc.) of times the user 104 makes a purchase in response to a recommendation feature 110 associated with a first psychological type 112. Additionally or alternatively, the user data can be obtained from a set of data sources 116. For example, the monitoring component 402 can query a search engine for data regarding the user 104, and discover that the user 104 is a member of an online sky diving forum.

The determination component 404 classifies, decides, or otherwise determines a psychological type 112 corresponding to the user 104 based on the profile 118. Returning to a prior example, if the quantity of times the user 104 makes a purchase in response to the recommendation feature 110 associated with a first psychological type 112 satisfies a set of correspondence criteria, then the determination component 404 can determine that the user 104 corresponds to the first psychological type 112. The set of correspondence criteria can include but is not limited to a click-through threshold, a purchase threshold, an add-to-wish list threshold, a views threshold, and/or a viewing time threshold. As an additional or alternative example, the determination component 404 can classify the user 104 as an adventurous psychological type 112 based on the user's 104 membership in the online sky diving forum.

The update component 406 can alter, modify, or otherwise update the psychological type 112 corresponding to the user 104 based on determinations made by the determination component 404. For example, the user 104 can initially be determined to correspond to a first psychological type based on responses to a set of psychological profiling questions. In response to the determination component 404 determining that the user 104 corresponds to a second psychological type based on the set of user data, the update component 406 can update the profile 118 associated with the user 104 to reflect that the user 104 corresponds to the second psychological type 112.

It is to be appreciated that the user 104 may not correspond to a single psychological type included in the set of psychological types 112. The update component 406 can update the profile 118 associated with the user 104 to reflect that the user 104 corresponds to hybrid psychological type. For example, a user 104 can correspond to a first psychological type 112 for a first user action, and a second psychological type 112 for a second user action. As an additional or alternative example, the update component 406 can update the profile 118 associated with the user 104 to reflect percentages of correspondence to a subset of the psychological types 112. For instance, the user 104 can be classified as 80% a first psychological type and 20% a second psychological type.

The generation component 408 can generate, create, or otherwise add psychological types to the set of psychological types. Returning to the previous example, if a quantity of users corresponding to a hybrid psychological type satisfies a predetermined creation threshold, then the generation component 408 can include the hybrid psychological type in the set of psychological types. As an additional or alternative example, the generation component 408 can add new psychological types to the set of psychological types 112 based on data obtained from an external source (e.g., data source(s) 116). For instance, the generation component 408 can inspect an online medical journal, and add a new psychological type to the set of psychological types 112 based on the data included in the medical journal.

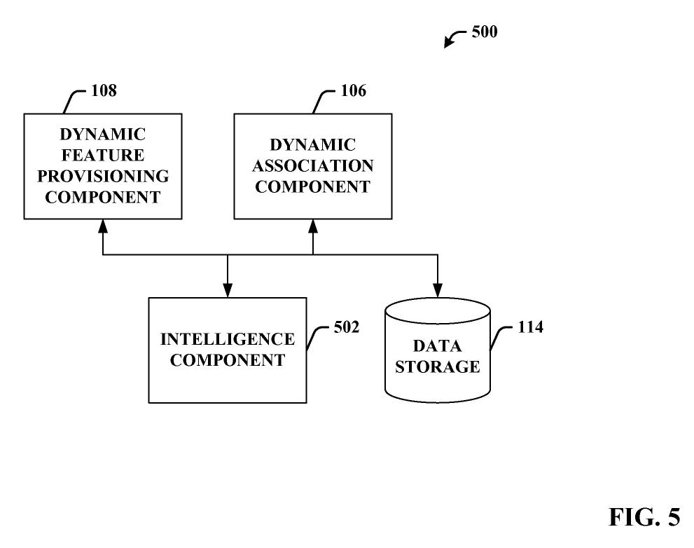

Referring now to FIG. 5, system 500 that can provide for or aid with various inferences or intelligent determinations is depicted. Generally, system 500 can include all or a portion of the dynamic feature provisioning component 108, and the dynamic association component 106 as substantially described herein. In addition to what has been described, the above-mentioned components can make intelligent determinations or inferences. For example, the dynamic provisioning component 106 can intelligently determine or infer modifications of associations of psychological types 112 and features 110. Likewise, the dynamic association component 106 can also employ intelligent determinations or inferences in connection with determining a psychological type 112 corresponding to a user 104. Any of the foregoing inferences can potentially be based upon, e.g., Bayesian probabilities or confidence measures or based upon machine learning techniques related to historical analysis, feedback, and/or other determinations or inferences.

In addition, system 500 can also include an intelligence component 502 that can provide for or aid in various inferences or determinations. In particular, in accordance with or in addition to what has been described supra with respect to intelligent determination or inferences provided by various components described herein. For example, all or portions of the dynamic association component 106, and the dynamic feature provisioning component 108 (as well as other components described herein) can be operatively coupled to intelligence component 502. Additionally or alternatively, all or portions of intelligence component 502 can be included in one or more components described herein. Moreover, intelligence component 502 will typically have access to all or portions of data sets described herein, such as in the data storage 114.

Accordingly, in order to provide for or aid in the numerous inferences described herein, intelligence component 502 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

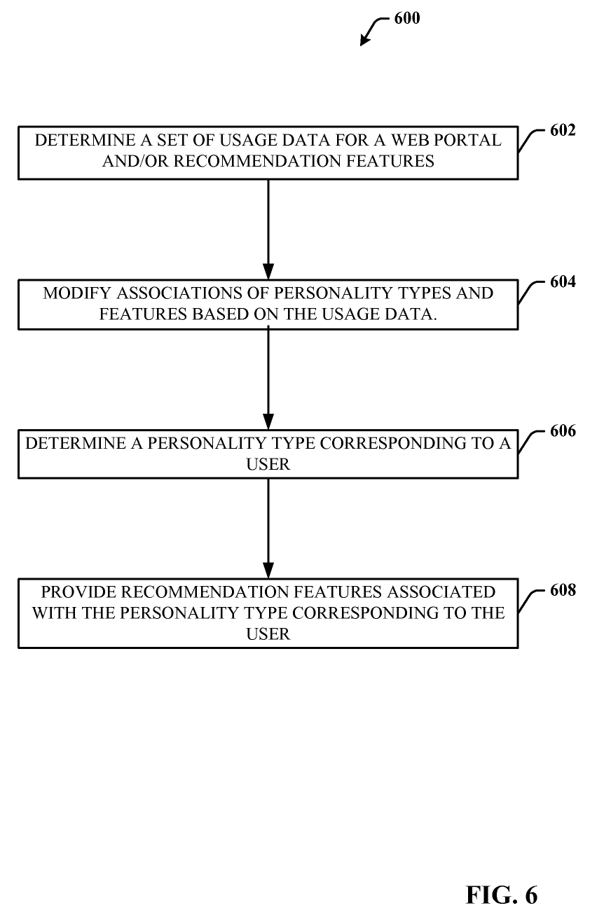

In view of the example systems described supra, methods that may be implemented in accordance with the described subject matter may be better appreciated with reference to the flow chart of FIGS. 6-8. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, illustrated is an example methodology for dynamic recommendations based on psychological types 600 in accordance with various aspects described herein. Methodology 600 can begin at block 602, wherein a set of usage data for a network site, such as a web portal, and/or recommendation features employed in the web portal is determined. The usage data includes user actions, such as viewing items, searching items, purchasing items, recommending items (e.g., via a social network, electronic mail, etc.), adding/removing items from a favorites lists (e.g., wish list, etc.), rating items, and/or correlations of respective recommendation features to the user actions. For example, the usage data can include a quantity (or percentage) of users corresponding to a first psychological type that made a purchase in response to a first recommendation feature.

At 604, the associations of psychological types and recommendation features are modified based on the usage data. Returning to the previous example, if the quantity of users corresponding to the first psychological type that made a purchase in response to a first recommendation feature does not satisfy a set of recommendation criteria, then the first recommendation feature and the first psychological type can be disassociated (or not associated). The set of recommendation criteria can include but is not limited to a click-through threshold, a purchase threshold, an add-to-wish list threshold, a views threshold, and/or a viewing time threshold.

As an additional or alternative example, the psychological types are associated with recommendation schemes. The recommendation schemes can include subsets of recommendation features. Associations of psychological types and recommendation schemes can be modified based on the usage data. For example, if a percentage of users corresponding to a second psychological type that made a purchase in response to a first recommendation scheme satisfies the set of recommendation criteria, then the first recommendation scheme can be associated with the second psychological type. The recommendation schemes can include but are not limited to collaborative filtering, content-based filtering, authoritative recommendation systems, blended predictive systems, and/or hybrid recommender systems.

At 606, a psychological type corresponding to a user is determined. The psychological type can be determined based on explicit input from the user (e.g., question and answer, etc.), and/or implicitly determined based on a set of user data for the user. For example, if the user employs a first recommendation feature an amount of times satisfying a feature usage threshold, then the user can be determined as corresponding to the psychological type corresponding to the first recommendation feature. Additionally or alternatively, the user data can include data gathered from a set of open source or publicly available sources of information, including but not limited to websites, search engine results, social networking websites, online groups, online subscriptions, and so forth. For example, the user can be classified as a first psychological type based on membership in an organization.

At 608, recommendation features associated with the psychological type corresponding to the user are provided to the user during interaction with the web portal. For example, authoritative/expert recommendation features can be associated with a conformist psychological type. If it is determined that the user has a conformist psychological type, then authoritative/expert recommendation features (e.g., reviewer ratings, recommendations, etc.) can be provided to the user during interaction with the web portal to assist in making purchases.

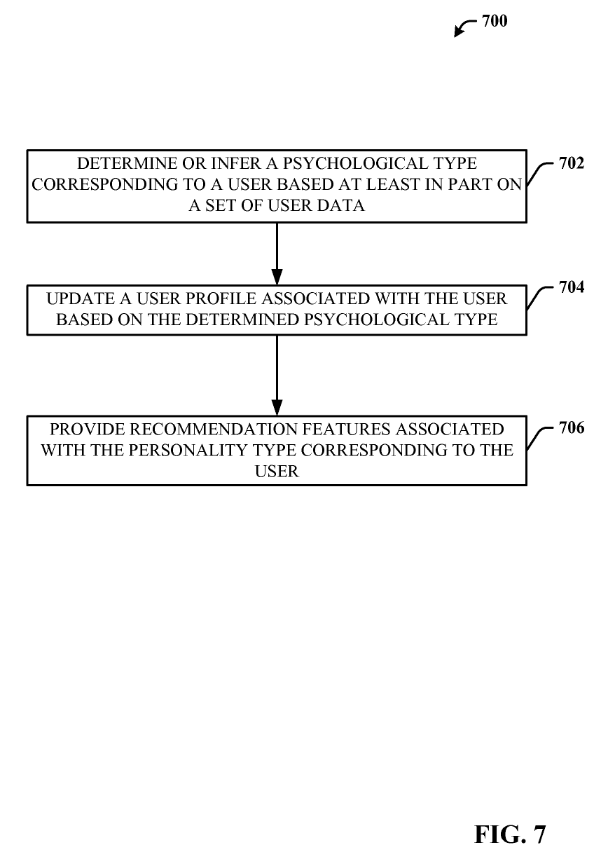

Turning to FIG. 7, illustrated is an example methodology for dynamic recommendations based on psychological types 700 in accordance with various aspects described herein. Methodology 700 can begin at block 702, wherein a psychological type corresponding to a user is determined based at least in part on a set of user data. The set of user data can be explicitly and/or implicitly obtained. For example, the user can explicitly provide a first subset of the user data as responses to a set of psychological profiling questions. As an additional or alternative example, a second subset of the user data can be implicitly determined based at least in part on user actions (e.g., viewing items, searching items, purchasing items, recommending items, adding/removing items from a favorites lists, rating items, etc.), and/or data obtained from a set of data sources.

At 704, a profile associated with the user is updated based on the determined psychological type. For example, the user can initially be determined to correspond to a first psychological type based on responses to a set of psychological profiling questions. In response to determining that the user corresponds to a second psychological type based on the set of user data, the profile associated with the user can be updated to reflect that the user corresponds to the second psychological type.

At 706, recommendation features associated with the psychological type corresponding to the user are provided to the user during interaction with the web portal. For example, collaborative recommendation features can be associated with an adventurous psychological type. If it is determined that the user has an adventurous psychological type, then collaborative recommendation features can be provided to the user during interaction with the web portal to assist the user with making purchases and/or finding desirable items.

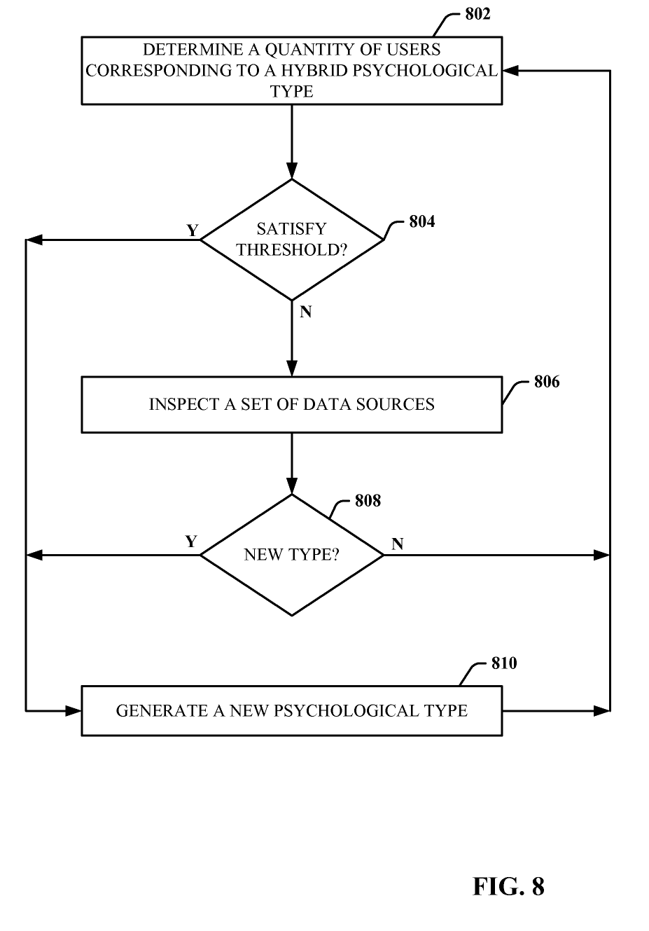

FIG. 8 illustrates an example methodology for dynamic recommendations based on psychological types 800 in accordance with various aspects described herein. Methodology 800 can begin at block 802, wherein a quantity of users corresponding to a hybrid psychological type is determined. A user of a network site, such as a web portal (online shopping portal, etc.), may not correspond to a single psychological type included in a set of psychological types. For example, the user can correspond to a first psychological type for a first user action, and a second psychological type for a second user action. As an additional or alternative example, the user can be classified as a first percentage (e.g., 60%) of the first psychological type and a second percentage of a second psychological type (e.g., 40%).

At 804, a determination is made whether the quantity of users corresponding to a hybrid psychological type satisfies a predetermined threshold. For instance, the predetermined threshold can be five percent of a total quantity of users of the web portal. At 806, if it is determined that the quantity of users corresponding to the hybrid psychological type does not satisfy the set of generation criteria (N at 804), then a set of data sources are inspected. The set of data sources can include for example, websites, medical journals, publications, etc. At 808, a determination is made whether the data sources include information regarding a new psychological type. For example, a medical journal can include a study regarding a psychological type not previously included in the set of psychological types.

At 810, if it is determined that the data source includes information regarding a new psychological type (Y at 808), then the new psychological type can be included in the set of psychological types. Returning to 804, if it is determined that the quantity of users corresponding to the hybrid psychological type satisfies the predetermined threshold (Y at 804), then a new psychological type based on the hybrid psychological type can be included in the set of psychological types.

### Exemplary Networked and Distributed Environments

One of ordinary skill in the art can appreciate that the various non-limiting embodiments of the shared shopping systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

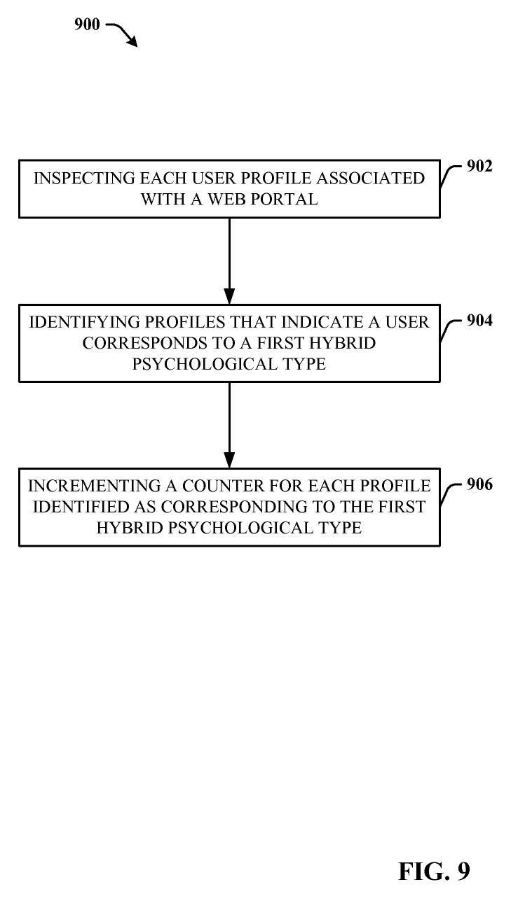

FIG. 9 illustrates a flow chart for an exemplary non-limiting system that provides for dynamic recommendations based on psychological types in accordance with various aspects described herein. At block 902, each user profile (e.g., profiles 118) associated with a web portal (e.g., web portal 102) is inspected (e.g., using the generating component 408). At 904, profiles indicating that a user corresponds to a first hybrid psychological type are identified. For example, the first hybrid psychological type can include a classification consisting of a first percentage (e.g., 60%) of a first psychological type, and a second percentage of a second psychological type (e.g., 40%). At 906, a counter is incremented for each profile identified as corresponding to the first hybrid psychological type. The counter designates the total number of users of the web portal corresponding to the first hybrid psychological type.

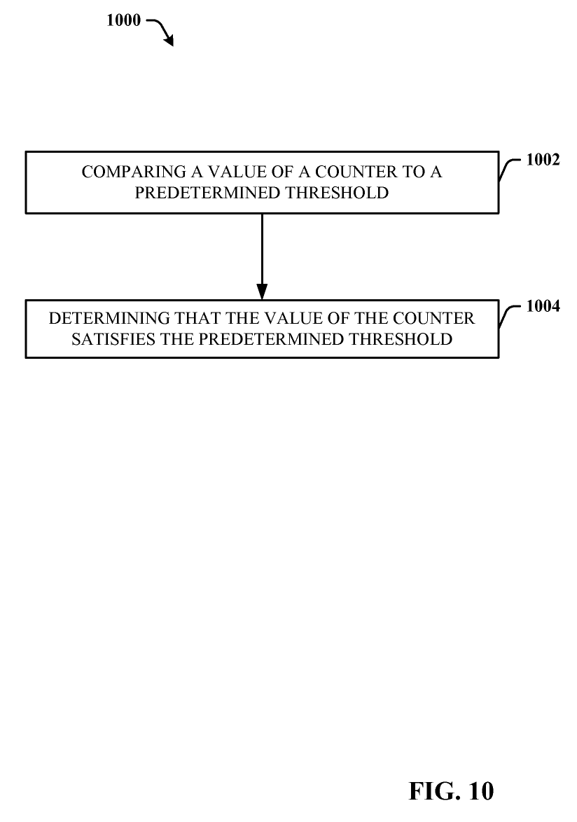

FIG. 10 illustrates a flow chart for an exemplary non-limiting system that provides for dynamic recommendations based on psychological types in accordance with various aspects described herein. At block 1002, a value of counter is compared to a predetermined threshold (e.g., using the generation component 408). For example, the value of the counter can contain a quantity of users corresponding to a first hybrid psychological type. At block 1004, it is determined that the value of the counter satisfies the predetermined threshold. For example, the predetermined threshold can include a minimum value required to generate a new psychological type, and if the value of the counter is greater than the minimum value, then the predetermined threshold is satisfied.

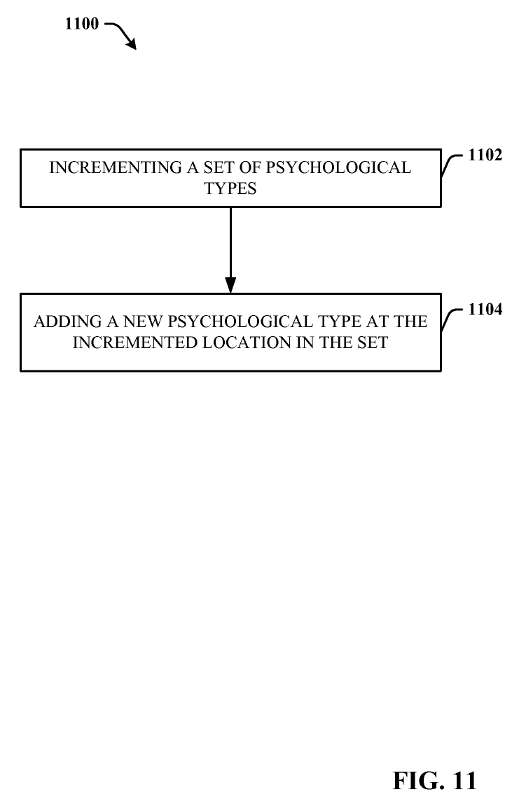

FIG. 11 illustrates a flow chart for an exemplary non-limiting system that provides for dynamic recommendations based on psychological types in accordance with various aspects described herein. At block 1102, a set of psychological types associated with a web portal is incremented. For example, the web portal can include X associated psychological types, and the set of psychological types can be incremented to X+1, where X is an integer. Additionally or alternatively, a first empty location in the set of psychological types can be located. At block 1104, a new psychological type (e.g., the first hybrid psychological type) is added to the set of psychological types at the incremented (or empty) location (e.g., X+1).

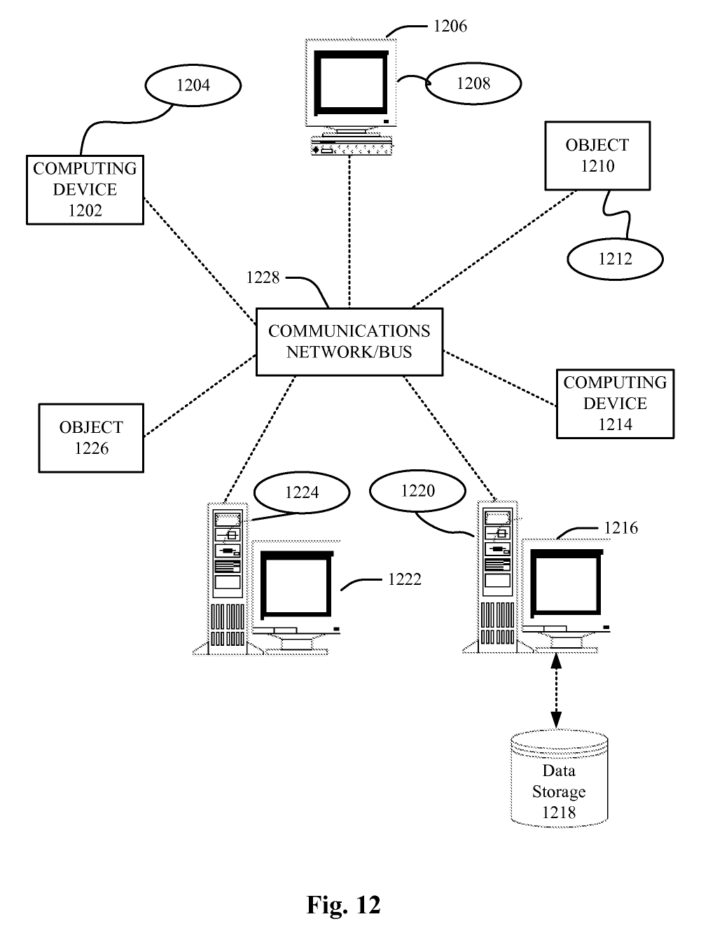

FIG. 12 provides a schematic diagram of an exemplary networked or distributed computing environment. The distributed computing environment comprises computing objects 1210, 1212, etc. and computing objects or devices 1220, 1222, 1224, 1226, 1228, etc., which may include programs, methods, data stores, programmable logic, etc., as represented by applications 1230, 1232, 1234, 1236, 1238. It can be appreciated that computing objects 1210, 1212, etc. and computing objects or devices 1220, 1222, 1224, 1226, 1228, etc. may comprise different devices, such as personal digital assistants (PDAs), audio/video devices, mobile phones, MP3 players, personal computers, laptops, etc.

Each computing object 1210, 1212, etc. and computing objects or devices 1220, 1222, 1224, 1226, 1228, etc. can communicate with one or more other computing objects 1210, 1212, etc. and computing objects or devices 1220, 1222, 1224, 1226, 1228, etc. by way of the communications network 1240, either directly or indirectly. Even though illustrated as a single element in FIG. 12, communications network 1240 may comprise other computing objects and computing devices that provide services to the system of FIG. 12, and/or may represent multiple interconnected networks, which are not shown. Each computing object 1210, 1212, etc. or computing object or device 1220, 1222, 1224, 1226, 1228, etc. can also contain an application, such as applications 1230, 1232, 1234, 1236, 1238, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 12, as a non-limiting example, computing objects or devices 1220, 1222, 1224, 1226, 1228, etc. can be thought of as clients and computing objects 1210, 1212, etc. can be thought of as servers where computing objects 1210, 1212, etc., acting as servers provide data services, such as receiving data from client computing objects or devices 1220, 1222, 1224, 1226, 1228, etc., storing of data, processing of data, transmitting data to client computing objects or devices 1220, 1222, 1224, 1226, 1228, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1240 or bus is the Internet, for example, the computing objects 1210, 1212, etc. can be Web servers with which other computing objects or devices 1220, 1222, 1224, 1226, 1228, etc. communicate via any of a number of known protocols, such as the hypertext transfer protocol (HTTP). Computing objects 1210, 1212, etc. acting as servers may also serve as clients, e.g., computing objects or devices 1220, 1222, 1224, 1226, 1228, etc., as may be characteristic of a distributed computing environment.

### Exemplary Computing Device

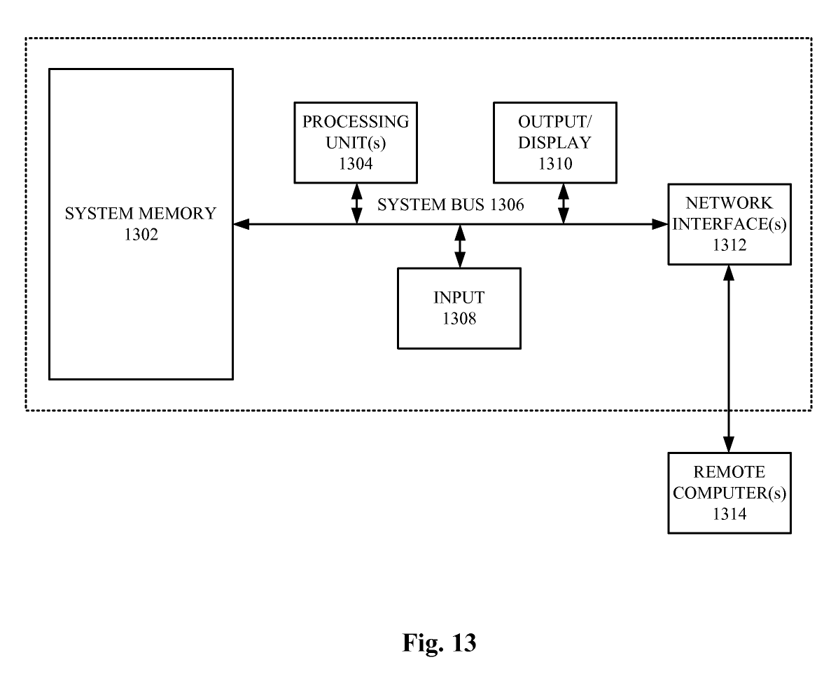

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 13 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 13 thus illustrates an example of a suitable computing system environment 1300 in which one or aspects of the non-limiting embodiments described herein can be implemented, although as made clear above, the computing system environment 1300 is only one example of a suitable computing environment and is not intended to suggest any limitation as to scope of use or functionality. Neither should the computing system environment 1300 be interpreted as having any dependency or requirement relating to any one or combination of components illustrated in the exemplary computing system environment 1300.

With reference to FIG. 13, an exemplary remote device for implementing one or more non-limiting embodiments includes a general purpose computing device in the form of a computer 1310. Components of computer 1310 may include, but are not limited to, a processing unit 1320, a system memory 1330, and a system bus 1322 that couples various system components including the system memory to the processing unit 1320.

Computer 1310 typically includes a variety of computer readable media and can be any available media that can be accessed by computer 1310. The system memory 1330 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1330 may also include an operating system, application programs, other program modules, and program data.

A user can enter commands and information into the computer 1310 through input devices 1340. A monitor or other type of display device is also connected to the system bus 1322 via an interface, such as output interface 1350. In addition to a monitor, computers can also include other peripheral output devices such as speakers and a printer, which may be connected through output interface 1350.

The computer 1310 may operate in a networked or distributed environment using logical connections to one or more other remote computers, such as remote computer 1370. The remote computer 1370 may be a personal computer, a server, a router, a network PC, a peer device or other common network node, or any other remote media consumption or transmission device, and may include any or all of the elements described above relative to the computer 1310. The logical connections depicted in FIG. 13 include a network 1372, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” or “a set of criterion” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A system, comprising:
a dynamic association component configured to associate recommendation features employed in a network site with respective psychological types; and
a dynamic feature provisioning component configured to determine a psychological type corresponding to a user, and provide the recommendation features associated with the psychological type to the user.

2. The system of claim 1, further comprising a usage component configured to monitor usage of at least one of the network site or recommendation features by a set of users.

3. The system of claim 2, wherein the usage of the network site includes at least one of: a viewing of an item, a search of the item, a purchase of the item, a recommendation of the item, an addition of the item to a set of user designated favorites, a removal of the item from the set of user designated of favorites, or a rating of the item.

4. The system of claim, 2 further comprising a modification component configured to modify associations of the recommendation features and the respective psychological types based at least in part on the monitored usage of at least one of the network site or the recommendation features.

5. The system of claim 1, wherein the dynamic feature provisioning component determines the psychological type corresponding to the user based at least in part on a profile associated with the user.

6. The system of claim 5, further comprising a monitoring component that monitors at least one of interaction with the network site by the user, or a set of data sources for information regarding the user, and updates a profile associated with the user based on the monitoring.

7. The system of claim 6, wherein the set of data sources include at least one of a website, a search engine, a social networking website, an online group, or an online subscription.

8. The system of claim 6, further comprising an update component that updates the profile associated with the user based on the monitoring.

9. A method, comprising:
determining a set of usage data for at least one of a network site or a set of recommendation features employed in the network site;
modifying associations of respective personality types and recommendation features based on the set of usage data;
determining at least one of the respective personality types corresponding to a user of the network site; and
providing recommendation features to the user associated with the at least one respective personality type.

10. The method of claim 9, wherein the determining the set of usage data for the network site includes monitoring at least one of viewing items, searching items, purchasing items, recommending items, adding items to a wish list, removing items from the wish list, or rating items by a set of users.

11. The method of claim 9, wherein the determining the at least one respective personality type corresponding to the user, includes determining the at least one respective personality type corresponding to the user based at least in part on a profile associated with the user.

12. The method of claim 11, further comprising monitoring interaction with the network site by the user, and updating the profile associated based on the monitored interaction.

13. The method of claim 11, further comprising monitoring a set of data sources for information regarding the user, and updating the profile associated with the user based on the information regarding the user.

14. The method of claim 13, wherein the monitoring the set of data sources set of data sources, includes monitoring at least one of a website, a search engine, a social networking website, an online group, or an online subscription.

15. A computer readable storage medium comprising computer executable instructions that, in response to execution, cause a computing system including at least one processor to perform operations, comprising:
determining a psychological type corresponding to a user based at least in part on a set of user data;
updating a profile associated with the user based on the determined psychological type; and
providing recommendation features associated with the personality type corresponding to the user.

16. The computer readable storage medium of claim 15, wherein the determining the psychological type corresponding to the user based at least in part on the set of user data, includes obtaining information regarding the user from a set of data sources, and determining the psychological type corresponding to the user based at least in part on the obtained information.

17. The computer readable storage medium of claim 16, wherein the obtaining information regarding the user from the set of data sources, includes obtaining information from at least one of a website, a search engine, a social networking website, an online group, or an online subscription.

18. The computer readable storage medium of claim 15, wherein the determining the psychological type corresponding to the user based at least in part on the set of user data, includes monitoring interaction with the network site by the user, and determining the psychological type corresponding to the user based at least in part on the monitored interaction.

19. A system, comprising:
means for determining a quantity of web portal users corresponding to a hybrid psychological type, wherein the hybrid psychological type is a combination of at least two psychological types included in a set of psychological types;
means for determining that the quantity of users corresponding to the hybrid psychological type satisfies a predetermined threshold; and
in response to the quantity of users corresponding to the hybrid psychological type satisfying the predetermined threshold, means for adding the hybrid psychological type to the set of psychological types.

20. The system of claim 19, further comprising
means for inspecting a set of data sources;
means for determining information regarding a psychologically type not currently included in the set of psychological types from the set of data sources; and
in response to determining information regarding the psychologically type not currently included in the set of psychological types, means for adding the psychological type to the set of psychological types.
